(19) United States
(12) Patent Application Publication
(10) Pub. No.: US 2009/0327758 A1
(43) Pub. Date: Dec. 31, 2009

(54) STORAGE APPARATUS AND DATA PROCESSING METHOD FOR STORAGE APPARATUS

(76) Inventors: Toshimitu SAKANAKA, Tokyo (JP); Shuichi YAGI, Ninomiya (JP); Yasuyuki NAGASOE, Kaisei (JP); Kenichi NISHIKAWA, Odawara (JP)

Correspondence Address: BRUNDIDGE & STANGER, P.C., 1700 DIAGONAL ROAD, SUITE 330, ALEXANDRIA, VA, 22314, US

(21) Appl. No.: 12/192,657

(22) Filed: Aug. 15, 2008

(30) Foreign Application Priority Data
Jun. 26, 2008 (JP) 2008-167624

(51) Int. Cl. G06F 12/14

(52) U.S. Cl. 713/193; 713/189; 711/E12.092

(57) ABSTRACT

A storage apparatus is provided, which allows a user to properly use an encrypted text and a plain text even when the storage apparatus has an encrypting function. An adaptor controlling transmission and reception of data to and from a memory device is provided with an encrypting function. Data requiring no encryption is transmitted to an adaptor having no encrypting function, and data to be encrypted is transmitted to the adaptor having an encrypting function. Thus, a user of the storage apparatus can properly use an encrypted text and a plain text.

### CROSS REFERENCES TO RELATED APPLICATIONS

This application relates to and claims priority from Japanese Patent Application No. P2008-167624, field on Jun. 26, 2008, the entire disclosure of which is incorporated herein by reference.

### BACKGROUND OF THE INVENTION

1. Field of the Invention

The present invention relates to a storage apparatus for controlling exchange of data and commands between a host computer and a memory device and, more particularly, to a storage apparatus capable of storing data in a memory device in an encrypted form.

2. Description of the Related Art

The advance of the information and communication society is accompanied by a continued dramatic increase in the volume of data handled by information processing systems. Under the circumstance, storage systems including a storage apparatus provided independently of a server and a host computer for centralized management of data are being developed. In such a storage system, a storage apparatus and a host computer are connected through a communication network such as an SAN.

According to iSCSI, a storage apparatus can transmit and receive data through a server host and an IP network, and encryption of data handled by a storage apparatus is becoming more important because of the risk of theft of memory devices in the storage apparatus and leakage of data from the same. From such a point of view, data are stored in a hard disk drive after being encrypted.

There are several approaches to encryption of data to be stored in a storage apparatus. A first approach is to encrypt the data in a host computer. A second approach is to provide an encryption apparatus such as an encryption switch between the host computer and the storage apparatus. A third approach is to provide the storage apparatus with the capability of performing a data encryption process.

Japanese Patent Laid-Open No. JP-A-2005-322201 discloses a storage system in which an encryption process is carried out. The storage system is formed by a channel interface unit having an interface to a server, a disk interface unit having an interface to a group of hard disks, a memory unit for storing data read from and to be written in the server or the group of hard disks, a switch unit, and the group of hard disks. The channel interface unit, the disk interface unit, and the memory unit are connected to each other through the switch unit, and an encryption process section is provided between a host interface section and a transfer control section in the channel interface unit.

Patent Document 1: JP-A-2005-322201

### SUMMARY OF THE INVENTION

An encryption process according to the first approach has a problem in that the encryption process consumes considerable amounts of control resources of a host computer. An encryption process according to the second approach has a problem in that I/O processing performance of a storage apparatus can be adversely affected by an encryption device.

An encryption process according to the third approach does not have such problems. However, when a channel interface unit having a port connected to a host computer is provided with an encryption process function as described in JP-A-2005-322201, data transmitted from the channel interface unit to a disk interface unit are entirely encrypted. Then, a user of a memory device has been unable to properly use encrypted and plain texts.

Under the circumstance, it is an object of the invention to provide a storage apparatus which allows a user to properly use encrypted and plain texts even when the storage device is provided with an encrypting function.

In order to achieve the object, in a storage apparatus according to the invention, an encryption process function is provided at some of a plurality of adaptors each of which controls transmission and reception of data to and from a memory device. Data requiring no encryption process are transmitted to the other adaptors having no encryption process function, and data to be encrypted are transmitted to the adaptors having an encryption process function. Thus, a user of the storage apparatus can properly use encrypted and plain texts.

As described above, the invention makes it possible to provide a storage apparatus which allows a user to use encrypted and plain texts properly even when the storage apparatus is provided with an encrypting function.

### BRIEF DESCRIPTION OF THE DRAWINGS

FIG. 1 is a block diagram of a storage system including a storage apparatus and a plurality of host computers;

FIG. 2 is a block diagram of a disk adaptor;

FIG. 3 shows a configuration of blocks of an adaptor module;

FIG. 4 is a block diagram showing connections between RAID groups formed by a plurality of HDDs and disk adaptors;

FIG. 5 is a disk adaptor management table showing whether each of the plurality of disk adaptors is enabled for encryption or not.

FIG. 6 is a management table (RAID group management table) showing relationships between RAID groups, disk adaptors forming part of the RAID groups, and encryption on/off settings made for the RAID groups;

FIG. 7 is a block diagram showing a memory structure of a storage apparatus;

FIG. 8 is a logical device management table showing an example of association between RAID groups (virtual devices) and logical devices;

FIG. 9 is a table showing association between RAID groups and HDDs forming the RAID groups;

FIG. 10 is a flow chart of steps executed by a management program of an SVP to set control information indicating whether a disk adaptor has an encrypting function or not;

FIG. 11 is a flow chart of processes for setting an encryption process on or off for an RAID group;

FIG. 12 is a flow chart showing a write process performed on a storage apparatus by a host computer;

FIG. 13 is a flow chart of steps performed by a disk adaptor to execute a read instruction from a host computer;

FIG. 14 is a flow chart for explaining formatting for encryption;

FIG. 15 is a flow chart showing migration processes performed after formatting for encryption is completed; and

FIG. 16 is a functional block diagram of an example of an encryption/decryption circuit.

### DETAILED DESCRIPTION OF THE INVENTION

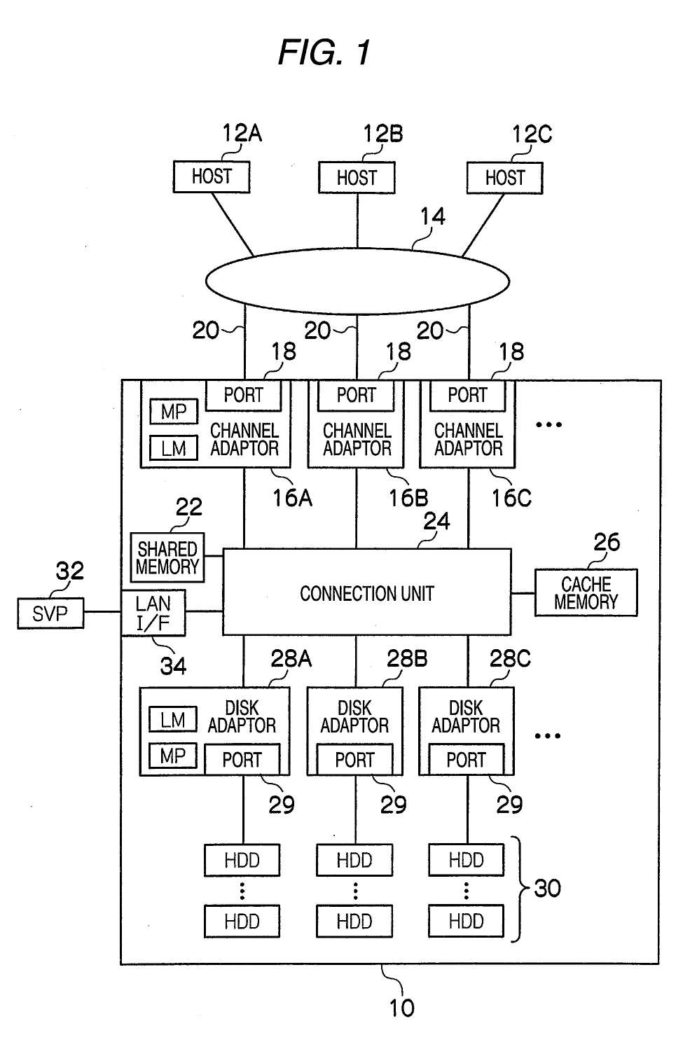

An embodiment of the invention will now be described. FIG. 1 is a block diagram of a storage system including a storage apparatus 10 and a plurality of host computers 12 (12A, 12B, and 12C). The host computers 12 are an example of apparatus hosting the storage apparatus. The host computers 12 and the storage apparatus 10 are connected through a network 14.

The host computers 12 are computer apparatus having information processing resources such as a CPU and a memory, and they may function as a server, a personal computer, a workstation, or a mainframe. The host computers 12 include information input devices such as a keyboard switch, a pointing device, and a microphone and information output devices such as a monitor display and a speaker.

Further, the host computers 12 logically recognize a memory area provided by the storage apparatus 10 and execute a business application program such as a database program using the logical memory area.

The storage apparatus 10 includes a plurality of channel adaptors 16 (16A, 16B, 16C) which are sections for controlling interface with the host computers 12. Each channel adaptor has a port 18, and the channel adaptor is connected to a host computer by connecting the port 18 to the communication network 14.

Referring to FIG. 1, paths between the host computers and the channel adaptors are controlled such that the host computers 12A, 12B, and 12C are connected to the channel adaptors 16A, 16B, and 16C, respectively.

The communication network 14 may be a LAN, SAN, internet, private line, or public line. For example, data communication between the host computers 12 and the storage apparatus 10 through a LAN is carried out according to TCP/IP (Transmission Control Protocol/Internet Protocol).

When a host computer 12 is connected to the storage apparatus 10 through the LAN, the host computer requests the storage apparatus to input or output data in files by specifying file names.

When a host computer 12 is connected to the storage apparatus 10 through an SAN, the host computer requests the storage apparatus to input or output data in blocks according to the fiber channel protocol, a block being a unit used for managing data in a memory area of an HDD provided by the storage.

For example, the storage apparatus 10 is provided in the form of a disk array subsystem. However, the invention is not limited to such a subsystem, and the storage apparatus 10 may be an intelligent fiber channel switch having advanced functions.

The storage apparatus 10 has a plurality of HDDs (Hard Disk Drives) 30 serving as memory media or memory devices and a plurality of disk adaptors 28 (28A, 28B, and 28C) for controlling data transfers to and from the HDDs. Each disk adaptor 28 has a port 29 connected to the plurality of HDDs 30. The channel adaptors 16 operate as interface control sections for the host computers 12, whereas the disk adaptors serve as interface control sections for HDDs. The connection between the port 29 and the plurality of HDDs 30 is provided by a Fiber Channel FC-AL or fabric or an SAS.

The channel adaptors 16 and the disk adaptors 28 are connected to each other through a connection unit (connection circuit) 24. A shared memory 22 and a cache memory 26 are connected to the connection unit 24. Each of the channel adaptors 16 and the disk adaptors 28 includes a microprocessor (MP) and a local memory (LM) that is paired with the microprocessor.

The microprocessor of a channel adaptor 16 executes a micro-program for processing a command sent from the host computer 12. The micro-program is provided in the local memory LM of the channel adaptor.

The microprocessor of a disk adaptor 28 executes a micro-program for controlling the plurality of HDDs 30. The micro-program is stored in the local memory of the disk adaptor.

In order to allow a process to be carried out in cooperation between the plurality of channel adaptors 16 and the plurality of disk adaptors 28, control information to be shared by the adaptors is provided in the shared memory 22. The microprocessors MP of the channel adaptors 16 and the disk adaptors 28 access the control information in the shared memory through the connection unit 24.

The channel adaptors 16 receive data read/write request commands and data associated therewith from the host computers 12, and the adaptors interpret and execute various commands.

A network address (e.g., an IP address or WWN) is assigned to each of the plurality of channel adaptors 16. Each of the channel adaptors 16 may have the function of acting as an independent NAS (Network Attached Storage).

When a channel adaptor 16 receives a data read or write command from the host computer 12, the adaptor stores the command in the shared memory 22. The relevant disk adaptor 28 refers to the shared memory 22 from time to time. When the disk adaptor finds an unprocessed read command, it reads the data from the HDD 30 and stores the data in the cache memory 26.

The channel adaptor 16 reads the data which has been transferred to the cache memory 26 and transmits it to the host computer 12 which has dispatched the command.

When the channel adaptor 16 receives a data write request from the host computer 12, the channel adaptor stores the write command in the shared memory 22 and stores the received data along with the same in the cache memory 26.

The disk adaptor 28 stores the data stored in the cache memory in a predetermined memory device 30 according to the command stored in the shared memory 22.

When each disk adaptor 28 inputs or outputs data to or from a memory device 30, the disk adaptor performs conversion between a logical address associated with the command from the host computer and a physical address in an HDD. Each disk adaptor 28 accesses data in a memory device 30 according to the RAID configuration of the same.

Each disk adaptor 28 monitors the state of the memory devices 30 from time to time, and results of monitoring are transmitted to an SVP (service processor) 32 through a LAN interface 34 connected to the connection unit 24.

The SVP 32 is a computer device (managing device) which manages and monitors the storage apparatus 10. The SVP 32 collects various types of ambient information and performance information from each of the channel adaptors 16 and the disk adaptors 28 through the connection unit 24.

A work area is set in the shared memory 22, and a management table, which will be described later, is also stored in the same. One or a plurality of the HDDs 30 may be used as disks for caching.

The connection unit 24 connects the channel adaptors 16, the disk adaptors 28, the cache memory 26, and the shared memory 22 to each other. For example, the connection unit 24 may be provided in the form of a high speed bus such as an ultrahigh speed cross-bar switch which transmits data through high-speed switching operations.

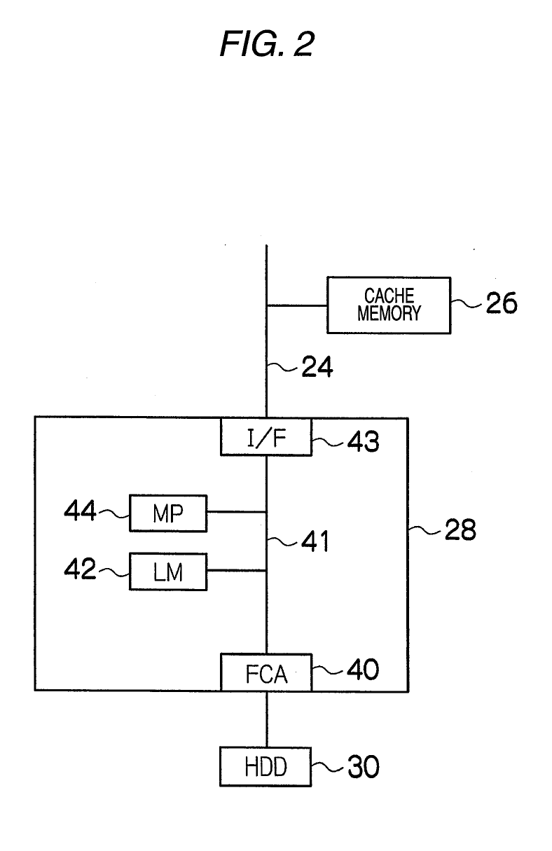

FIG. 2 is a block diagram of a disk adaptor. Reference numeral 41 represents an internal bus. A local memory (LM) 42 in which a micro-program for controlling the disk adaptor is stored as described above and a microprocessor (MP) 44 which controls the disk adaptor 28 based on the micro-program stored in the local memory as described above are connected to the internal bus.

The bus 41 is connected to an HDD 30 through a fiber channel adaptor module (FCA) 40 and connected to the connection unit 24 through an interface 43. The FCA of at least one of the plurality of disk adaptors 28 provided in the storage apparatus 10 includes an encryption/decryption module.

The disk adaptor 28 having the encrypting/decrypting function encrypts write data from the host computer and stores it in an HDD 30. In response to a read command from the host computer, the disk adaptor 28 decrypts encrypted data and transmits the data to the host computer.

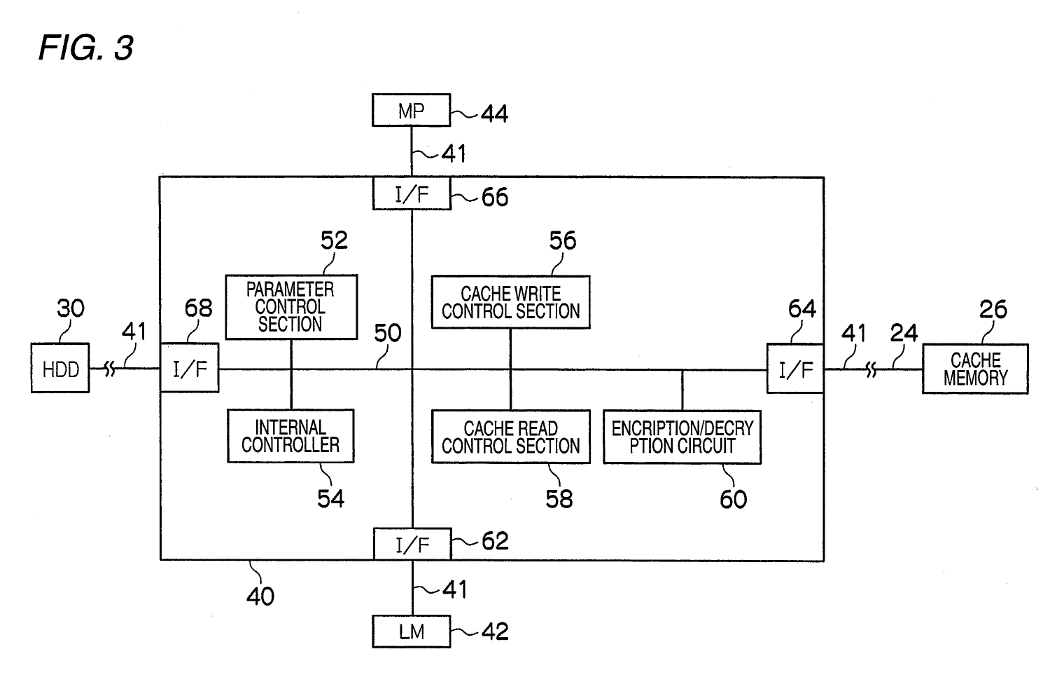

FIG. 3 shows a configuration of blocks of an adaptor module 40. The adaptor module 40 has a bus 50. A parameter control section 52, an internal controller 54, a cache read control section 58, and a cache write control section 56 are connected to the bus 50. In the case of the adaptor module 40 of the disk adaptor having the encryption process function, an encryption/decryption circuit 60 is further connected to the bus 50 to provide the adaptor module with an encrypting/decrypting function.

Reference numeral 68 represents an interface connecting the bus 50 and the HDDs 30. Reference numeral 66 represents an interface connecting the bus 50 and the microprocessor 44. Reference numeral 62 represents an interface connecting the local memory 42 and the bus 50. Reference numeral 64 represents an interface connecting the bus 50 and the cache memory 26.

The internal controller 54 exercises control over data exchange between the cache memory 26 and the HDDs 30 in the adaptor module 40. The parameter control section 52 sets parameters in the cache read control section 58 and the cache write control section 56, the parameters being associated with addresses in the cache memory where data is to be read or written.

The encryption/decryption circuit 60 encrypts data received from the cache memory 26 before it is transferred to an HDD 30 and decrypts data received from an HDD 30 before it is transferred to the cache memory 26.

In an adaptor module 40 having no encrypting/decrypting function, the circuit 60 is not provided. Even if the circuit is provided, its function is disabled. An adaptor module 40 having no encrypting/decrypting function according to the related art can be renewed to have an encrypting function by adding at least an encryption/decryption module 60 to the same.

When data is to be destaged from the cache memory 26 to an HDD 30, the internal controller 54 of the adaptor module 40 instructs the parameter control section 52 to read a parameter from the local memory 42 upon receipt of data transfer permit information from the HDD 30. The parameter control section 52 transfers the parameter read from the memory to the cache read control section 58.

The internal controller 54 causes the cache read control section 58 to access the data in the address of interest in the cache memory based on the parameter. The internal controller 54 causes the cache read control section 58 to transfer the data read from the cache memory 26 to the encryption/decryption circuit 60.

The encryption/decryption circuit 60 executes a predetermined type of encryption algorithm on the data read from the cache memory 26 to perform an encryption process on the same. The internal controller 54 transfers the encrypted data to the HDD 30 through the cache read control section 58.

When the adaptor module 40 is to stage data read from an HDD 30 onto the cache memory 26, the internal controller 54 causes the cache write control section 56 to transfer the data to the address in the cache memory 26 associated with a parameter specified by the parameter control section 52 after the encrypted data is decrypted.

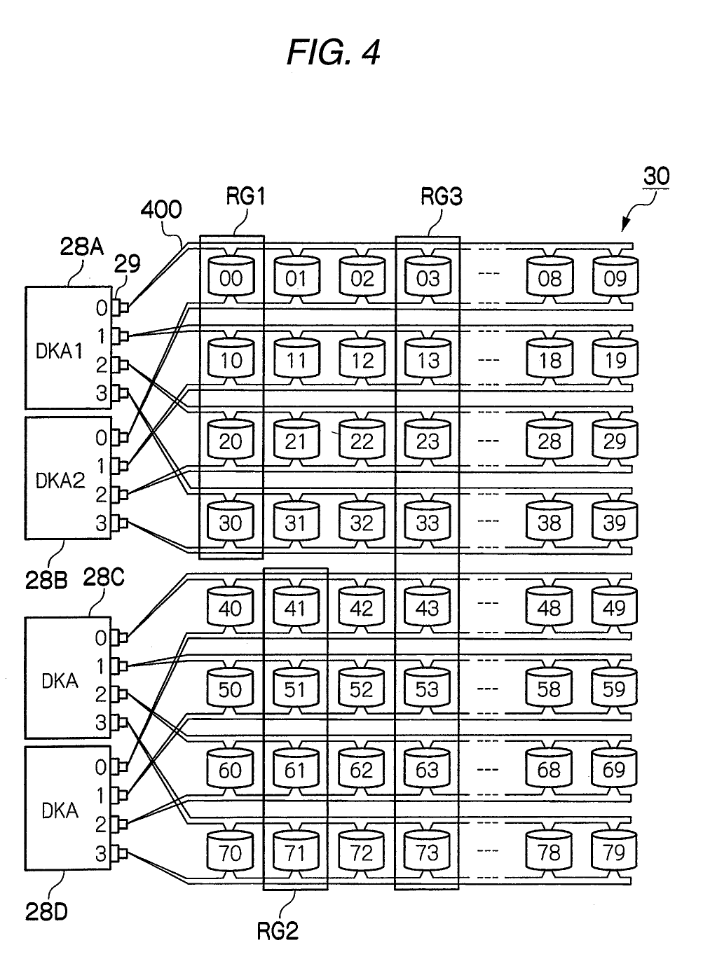

FIG. 4 is a block diagram showing connections between RAID groups formed by a plurality of HDDs 30 and the disk adaptors 28. Each of the plurality of disk adaptors 28A, 28B, 28C, and 28D is connected to a plurality of HDDs 30 through an FC-AL 400.

Each disk adaptor 28 has four ports 29. HDDs (00 to 09) connected to one FC-AL are connected to both of a pair of disk adaptors (disk adaptors 28A and 28B) to introduce redundancy in connections between the disk adaptors and the HDDs. The same thing is done for the other HDDs and the disk adaptors 28C and 28D.

For example, FIG. 4 shows that an RAID group (RG) 1 is formed by an HDD 00, HDD 10, HDD 20, and HDD 30; an RAID group 2 is formed by an HDD 41, HDD 51, HDD 61, and HDD 71; and an RAID group 3 is formed by an HDD 03, HDD 13, . . . , and HDD 73.

The number of disk adaptors to control the HDDs of an RAID group is determined by the RAID configuration of the RAID group or the number of the HDDs forming the RAID group. When an RAID group is formed of four HDDs, it is controlled by a pair of disk adaptors, i.e., the pair of the disk adaptors 28A and 28B or the pair of the disk adaptors 28C and 28D. When the number of HDDs forming an RAID group is eight, four disk adaptors, i.e., the disk adaptors 28A to 28D are connected to the HDDs.

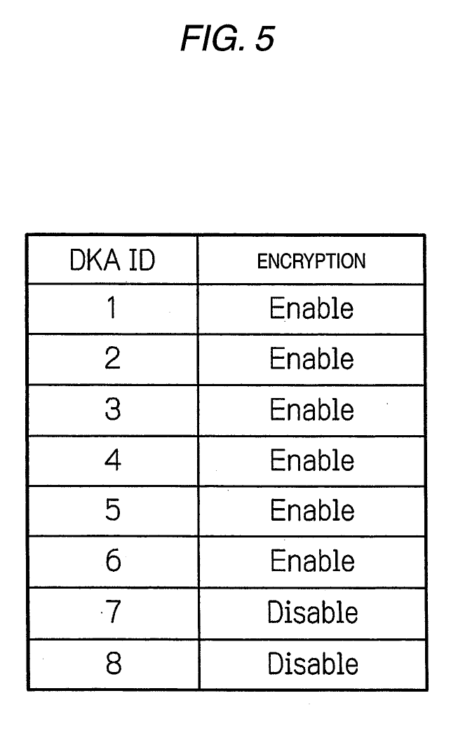

The storage apparatus 10 can encrypt data from the cache memory 26 to be stored in each RAID group. FIG. 5 is a disk adaptor management table showing whether each of the plurality of disk adaptors is enabled for encryption or not.

A management program in the managing device 32 provides a management client with information on whether a disk adaptor is enabled for encryption or not. For example, when an additional disk adopter is provided, the management program refers to LSI revision information recorded in registers of the disk adaptors (for example, the local memories 42 as shown in FIG. 3) to provide the management client with information on each of the plurality of disk adaptors such as indication of whether it is enabled for encryption or not. When a maintenance personnel specifies the package type of the disk adaptor to be added (or whether the disk adaptor is enabled for encryption or not) using the management client, the management program refers to information input based on the specification and registers the package type of the adaptor in the table shown in FIG. 5 to show whether the disk adaptor is enabled or disabled in terms of encryption.

When the maintenance personal using the management client registers an encryption-enabled disk adaptor as an encryption-disabled disk adaptor or vice versa, the management program compares the input information and the information in the register and provides user with information on the error. The SVP registers a disk adaptor encryption table in the shared memory 22.

In another embodiment of the invention, when the storage apparatus 10 is activated, the microprocessor MP of at least one of the plurality of channel adaptors 16 may read vendor names and device serial numbers from the plurality of disk adaptors 28 and may provide the management client of the SVP 32 with such information. Then, a user of the management client checks the vendor name and device serial number of each of the plurality of disk adaptors 28 on a management screen of a client apparatus to determine whether each of the plurality of disk adaptors 28 is enabled for encryption or not. The user inputs statements “encryption enabled” and “encryption disabled” with a GUI for input. Then, the input information is registered in association with ID of each of the plurality of disk adaptors on the disk adaptor management table, as shown in FIG. 5.

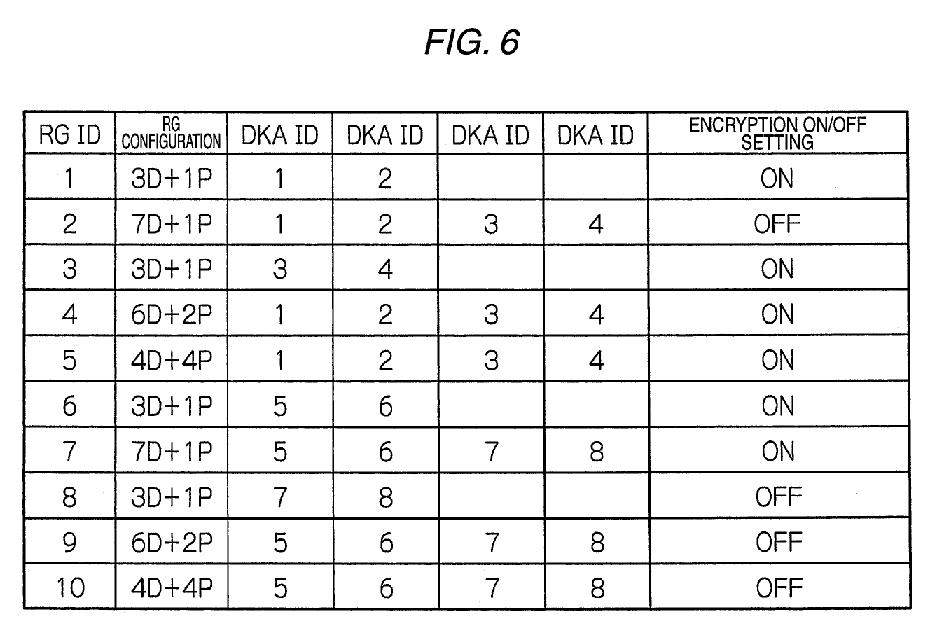

FIG. 6 is a management table (RAID group management table) showing relationships between RAID groups, disk adaptors forming part of the RAID groups, and encryption on/off settings made for the RAID groups.

A management client connected to the SVP 32 provides a user with a GUI for creating the management table. The user determines items associated with each RAID group entry (RG ID), the items including the configuration of the RAID (RG configuration), the disk adaptor(s) forming the RAID group (disk adaptor ID(s) which may be abbreviated to read “DKA ID(s)”), and an on/off setting deciding whether to activate data encryption for the RAID group or not. The user inputs the items to a management client terminal. The management client can recognize disk adaptor IDs by referring to the management table shown in FIG. 5.

Upon receipt of the input, the management program in the SVP 32 refers to the management table shown in FIG. 5 to determine whether encryption is enabled for all of a plurality of disk adaptors determined to be associated with a RAID group ID for which an encryption on/off setting is made. When it is determined that encryption is disabled for at least one of the disk adaptors, an encryption status “OFF” is set.

When it is determined that all of the disk adaptors are enabled for encryption, the management program in the SVP 32 sets encryption “ON” or “OFF” based on an input from the user. In this case, the term “OFF” means that the encrypting function is halted although the RAID group has the encrypting function.

Referring to FIG. 6, an RAID group 4 (RG ID: 4) is formed by four disk adaptors having disk adaptor IDs 1 to 4, and all of the disk adaptors are provided with the encrypting function (enabled for encryption) as shown in FIG. 5. Thus, an “ON” setting is made in the encryption setting column.

Referring to an RAID group 2, although the group is formed of a plurality of disk adaptors which are the same as those of the group 4, “OFF” state is registered in the encryption setting column according to an input from the user.

A RAID group 9 is formed of disk adaptors having disk adaptor IDs 5 to 8. Since encryption is disabled for the disk adaptors having IDs 7 and 8, the management program forcibly sets “OFF” state in the encryption setting column regardless of an input from the user.

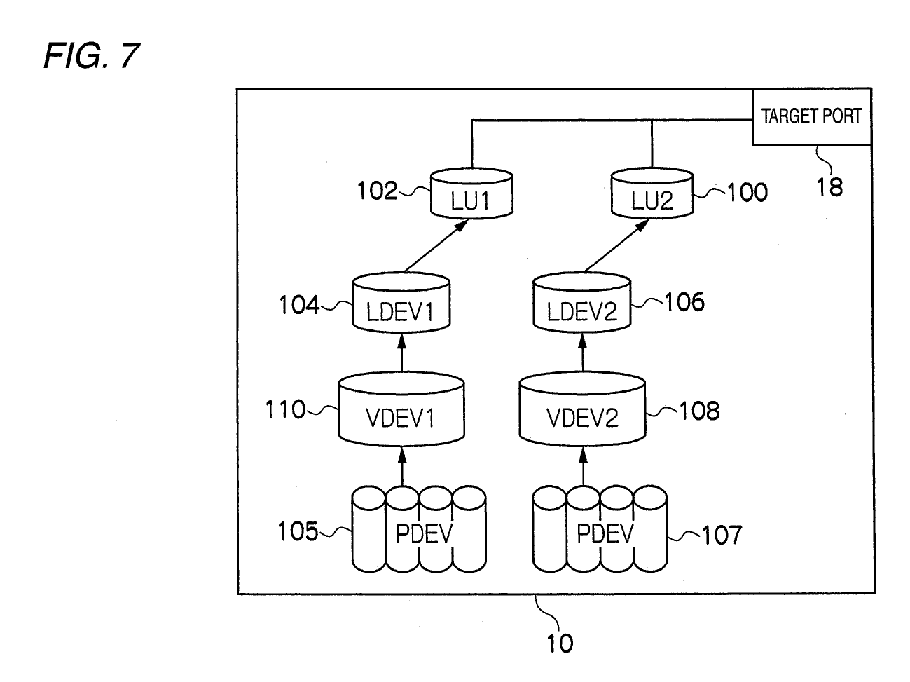

FIG. 7 is a block diagram showing a memory structure of the storage apparatus 10. The following description is based on an assumption that the block diagram is associated with any of the plurality of channel adaptors 16.

A host computer 12 is connected to a target port 18 of the channel adaptor 16 through the communication network 14.

LUs (Logical Units) 100 and 102 are entities in an SCSI target for which I/O commands are executed, and each of the LUs is mapped to the host computer 12 through the target port 18. The host computer recognizes each of the plurality of LUs and distinguishes between the LUs to dispatch data for the LU of interest.

Physical devices 105 and 107 correspond to the hard disk drives 30. A logical memory layer associating a physical memory area of a physical device and an LU is constituted by, for example, a plurality of layers.

One logical layer is constituted by virtual devices 108 and 110 which correspond to RAID groups, and another logical layer is constituted by logical devices 104 and 106.

HDDs belonging to the group categorized as physical devices collectively form one RAID group (virtual devices). The logical devices 104 and 106 are associated with the virtual devices 110 and 108, respectively. The logical devices are set as layers under the respective RAID groups and are formed by dividing the virtual devices into parts having a fixed length.

When the host computer 12 is an open-type computer, the logical devices are mapped to LUs. The open type host accesses a desired logical device by specifying or identifying an LUN (Logical Unit Number) and a logical block address. In the case of a mainframe-type host, the logical devices are directly recognized.

At least one logical device can be associated with each of the plurality of LUs. By associating a plurality of logical devices with one LU, a virtual expansion of the LU size can be achieved.

Data is dispatched from the host computer 12 to the logical devices belonging to an RAID group (virtual devices) for which encryption has been set, and the data is encrypted by the disk adaptor having the encrypting function and stored in the HDDs.

When a client of a host computer desires to have data encrypted, the client may access an LU to which an encryption-enabled logical device is mapped.

When a client of a host computer does not desire to have data encrypted, the client may access an LU to which an encryption-disabled logical device is mapped.

Association between the ports, LUs, logical devices, virtual devices, and the physical devices is established by the management client connected to the SVP. The association is registered in the shared memory 22 as a management table.

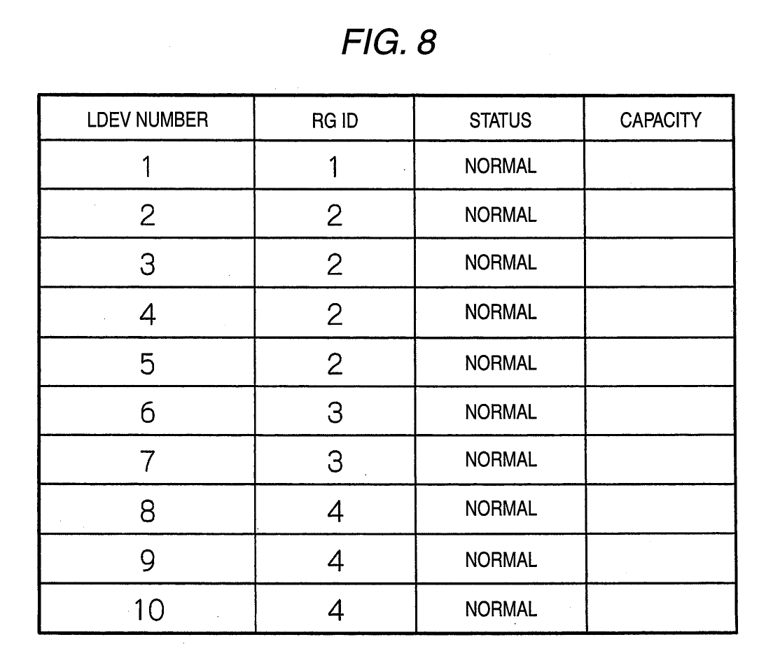

FIG. 8 is a logical device management table showing an example of association between the RAID groups (virtual devices) and logical devices. When the management client establishes association between the RAID groups and logical devices, the management program of the SVP registers various types of information in this table. A plurality of logical devices can be associated with one RAID group. When a logical device is closed, “closed” is registered in the “status” column. The management table is stored in the shared memory 22 by the SVP.

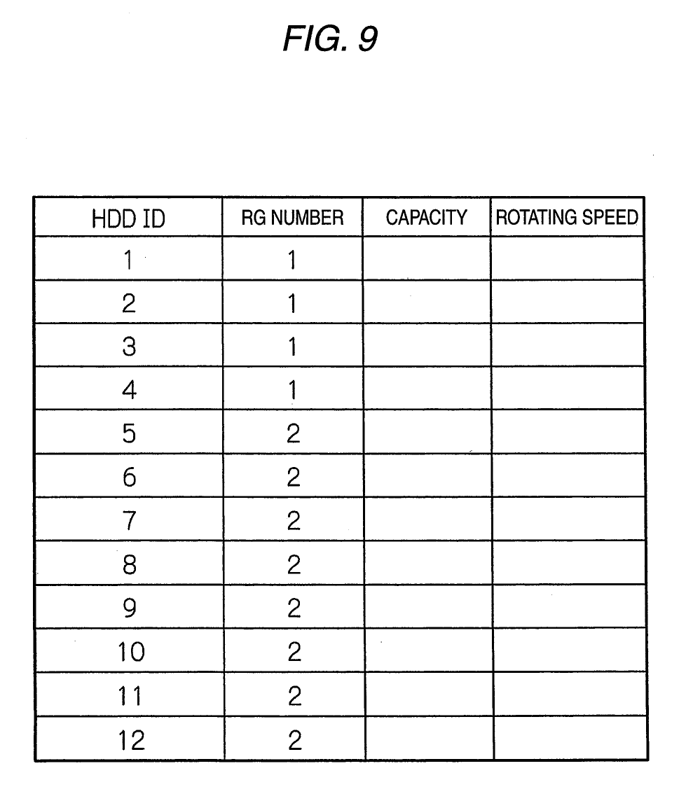

FIG. 9 is a table showing association between the RAID groups and the HDDs forming the RAID groups. As shown in FIG. 4, the number of HDDs forming an RAID group depends on the type or configuration of the RAID. Logical memory capacities set for the logical devices are registered in the “Capacity” columns of FIG. 8. Physical memory capacities of the HDDs are set in the “Capacity” columns of FIG. 9. Maximum rotating speeds of the HDDs are registered in the “Rotating Speed” columns.

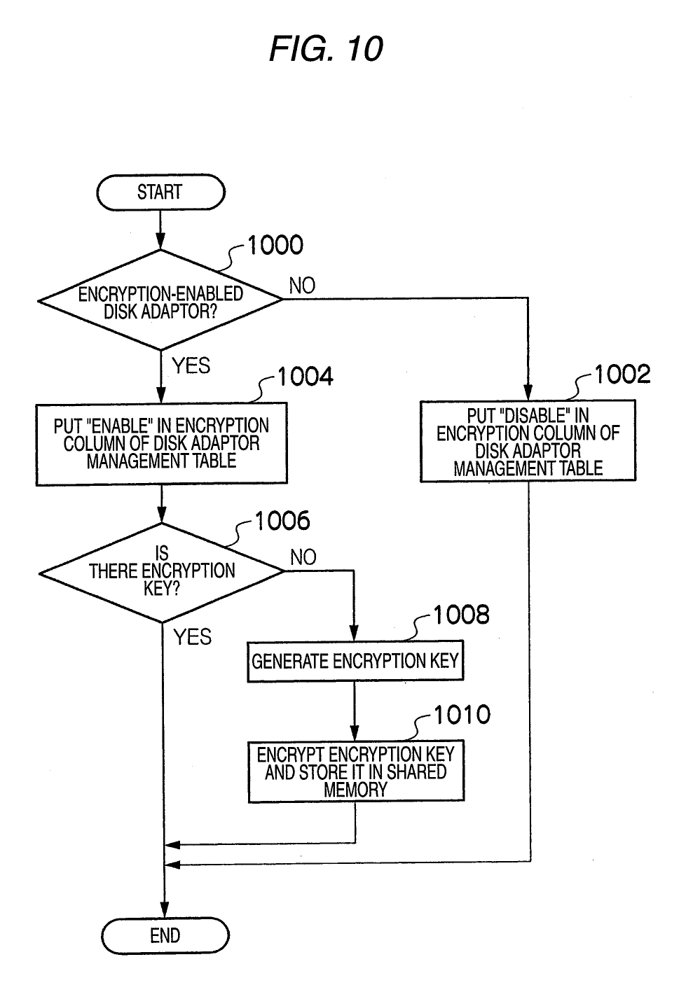

FIG. 10 is a flow chart of steps executed by the management program of the SVP to set control information indicating whether a disk adaptor has the encrypting function or not. The flow is started when the storage apparatus 10 is loaded with disk adaptors. An ID is assigned to each of the disk adaptors by the management program based on information input by the management client. Alternatively, the IDs are assigned based on predetermined information collected by the storage apparatus 10 from all disk adaptors. Then, it is determined whether each disk adaptor is enabled for encryption or not.

The management program determines whether encryption is enabled or disabled for each disk adaptor (step 1000) based on the information. When it is determined that encryption is disabled for a disk adaptor, “Disable” is registered in the management table shown in FIG. 5 as the result of determination of the disk adaptor (step 1002).

When a disk adaptor is determined to be enabled for encryption, “Enable” is registered in the management table shown in FIG. 5 as the result of determination of the disk adaptor (step 1004).

Then, the management program refers to the shared memory 22 to determine whether there is an encryption key or not (step 1006). If there is an encryption key, the flow is terminated.

When there is no encryption key, the SVP 32 generates an encryption key. Then, the generated encryption key is encrypted and stored in the shared memory 22 (step 1010), and the flow is terminated.

A code for decrypting encrypted data is set in the registers of the disk adaptors as described above. An encryption code may be set in local memories of the disk adaptors by the SVP. Alternatively, the code may be set in the registers by the SVP in a manner invisible to users.

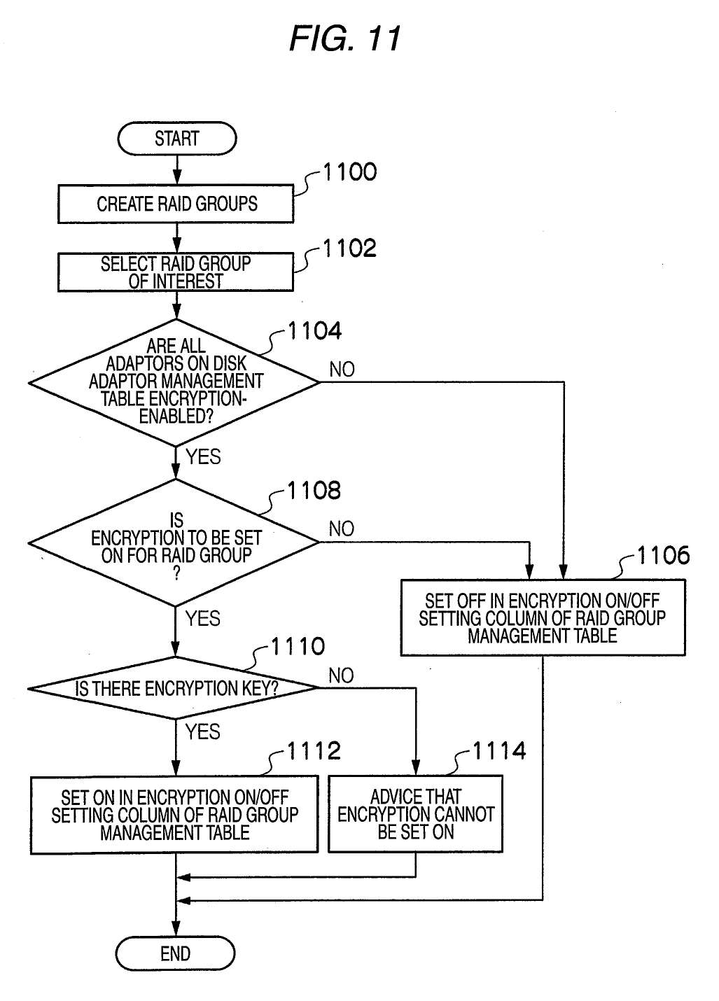

FIG. 11 is a flow chart of processes for setting the encryption process on or off for an RAID group. The management program of the SVP recognizes a plurality of disk adaptors, a plurality of HDDs, and connections between each disk adaptors and the plurality of HDDs as shown in FIG. 4, and creates RAID groups based on inputs from the management client (step 1100).

Based on inputs from the management client, the management program creates RAID groups by assigns an ID to each RAID group, setting a RAID configuration for each RAID group, and determining IDs of disk adaptors which form the RAID configuration.

Next, the management program selects an RAID group for which an encryption on/off setting is to be made based on an input from the management client (step 1102).

The management program checks the IDs of a plurality of disk adaptors forming the selected RAID group (see FIG. 6) and determines whether all of the disk adaptors having the relevant IDs are enabled for encryption or not with reference to the disk adaptor management table shown in FIG. 5 (step 1104).

When a negative determination is made by the management program, a control symbol “OFF” indicating that encryption should not be performed by the disk adaptors is registered in the relevant encryption ON/OFF setting column of the management table in FIG. 6, and the process is terminated (step 1106).

When all of the disk adaptors having the relevant IDs are enabled for encryption, the management client is requested to make an encryption setting for the RAID group (step 1108). When the management client provides an input instructing to set encryption “OFF”, the management program proceeds to step 1106 described above.

When encryption is to be set on, the management program checks whether there is an encryption key or not (step 1110). If there is an encryption key, an “on” setting is made in the encryption on/off setting column of the RAID management table. On the contrary, when an encryption key is not available for reasons such as breakage of the encryption key, the management program notifies the management client or host computer of the fact that encryption cannot be set on to urge the management client to generate or restore the encryption key, and the process is then terminated (step 1114).

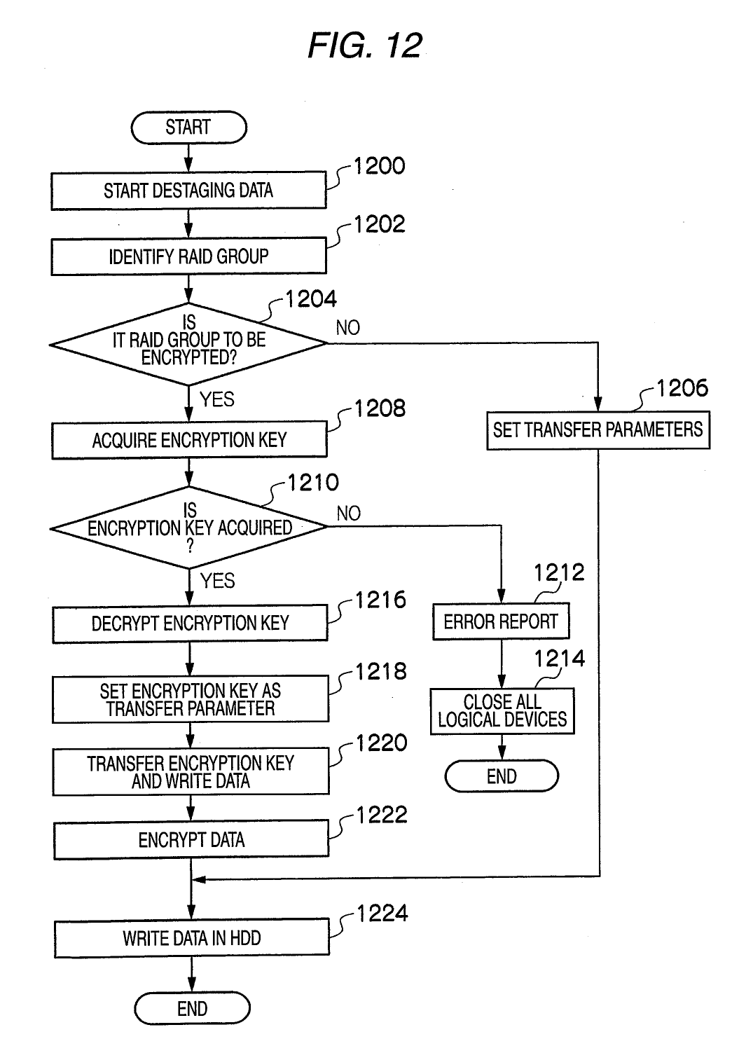

A write process performed on the storage apparatus by a host computer will now be described with reference to FIG. 12. Each of the plurality of disk adaptors 28 refers to the shared memory 22 asynchronously with the dispatching of a write command from the host computer.

The microprocessor of a disk adaptor 28 which has found a write command for the disk adaptor itself starts destaging dirty data in the cache memory 26 onto the HDD (step 1200).

The microprocessor determines a logical device number based on an identification number included in the write command to indicate a logical device in which write data is to be stored. Then, the microprocessor refers to the management table shown in FIG. 8 to find the ID of the RAID group including the logical device from the logical device number (step 1202).

The microprocessor of the disk adaptor refers to the encryption setting column of the RAID management table (FIG. 6) to check control information associated with the RAID group ID (step 1204). When the microprocessor detects control information “OFF”, a control instruction urging the internal controller 54 (FIG. 3) to read the data from the cache memory 26 and to transfer the data to an HDD without encrypting the same is stored in the local memory 42 along with relevant transfer parameters such as the address in the cache memory where the data is to be read (step 1206).

With reference to the control instruction, the internal controller 54 causes the parameter control section 52 to transfer the parameters to the cache read control section 58 with reference to the local memory.

The cache read control section reads the data from the cache memory 26 with reference to the parameters and transfers the data to the HDD 30 without transferring the data to the encryption/decryption circuit 60 (step 1224).

When the microprocessor detects that encryption is set on, it attempts to acquire an encrypted encryption key from the shared memory 22 (step 1208). When the encryption key is successfully acquired (step 1208), the microprocessor decrypts the encryption key (step 1216) and sets the decrypted encryption key as a transfer parameter (step 1218) and stores the parameter in the local memory 42. The internal controller 54 refers to the local memory 42 and instructs the parameter control section 52 to transfer the parameter including information on the encryption key to the cache read control section 58.

Upon receipt of the parameter, the cache memory control unit 58 transfers the encryption key and the data from the cache memory to the encryption/decryption circuit 60 (step 1220). The encryption/decryption circuit 60 encrypts the data using the encryption key (step 1222) and transfers the encrypted data to the cache read control section 58. The cache read control section transfers the encrypted data to the HDD 30 (step 1234).

When the microprocessor fails to acquire the encryption key, the microprocessor reports the write error to the SVP or the host computer (step 1212). The microprocessor closes all logical devices belonging to the RAID group and registers control information meaning “closed” in the Status columns of the logical device management table (FIG. 8) associated with the closed logical devices.

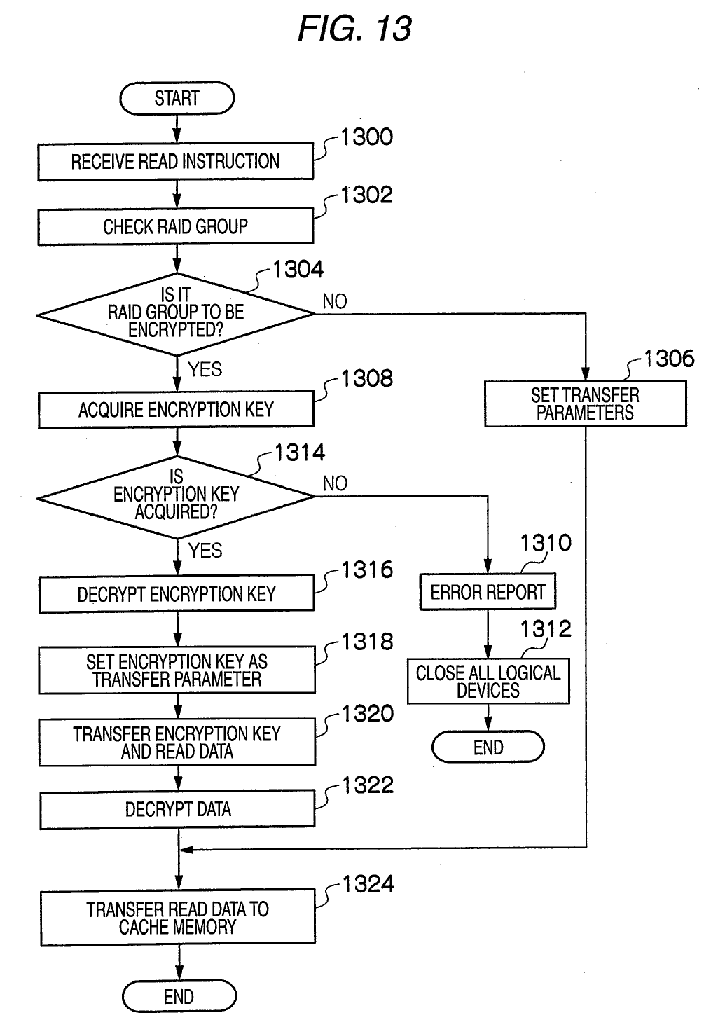

FIG. 13 shows a flow chart of steps performed by a disk adaptor to execute a read instruction from the host computer. When the microprocessor of the disk adaptor refers to the shared memory 22 and receives a read instruction from the host computer (step 1300), the microprocessor checks whether encryption is set on or off for the RAID group including the logical device that is the object of the read instruction (steps 1302 and 1304).

When the microprocessor determines that encryption is set off, it finds a physical address in an HDD from a logical address of the logical device included in the read instruction. The internal controller 54 instructs the parameter control section 52 to set a parameter associated with the physical address in the local memory 42 (step 1306).

The internal controller 54 instructs the parameter control section 52 to transfer the parameter set in the local memory 42 to the cache write control section 56.

Based on the parameter, the cache write control section 56 acquires the target read data in a plain text stored in an HDD 30 of the local memory and transfers the read data to the cache memory 26 without decrypting the same in the encryption/decryption circuit 60 (step 1324).

When encryption is set on for the RAID group, the cache write control section 56 transfers a decrypted encryption key (decrypted key) and encrypted data read from the HDD to the encryption/decryption circuit 60 in the same way as in FIG. 12 to decrypt the encrypted data into a plain text with the decrypted key, and the resultant plain text data is transferred to the cache memory 60 (steps 1308 to 1324).

When the microprocessor fails to acquire an encryption key at step 1314), an error report is sent (step 1310) and all logical devices are closed (step 1312) in the same way as in FIG. 12, and the read process is terminated.

The storage apparatus of the present embodiment allows data to migrate between RAID groups. For example, let us assume that an additional disk adaptor enabled for encryption is provided in the storage apparatus or that an encryption-disabled disk adaptor is replaced with an encryption-enabled disk adaptor. In such a case, data in a first RAID group can be encrypted by causing migration of data from the first RAID group to a second RAID group for which encryption is enabled. Such migration from the migration-starting RAID group to the RAID group that is the destination may take place on an RAID group by RAID group basis. Alternatively, migration may take place on a logical device by logical device basis.

When data in the first RAID group migrates to the second RAID group, the entire memory area of the second RAID group that is the destination of migration or the logical devices to which data is to migrate must be formatted for encryption.

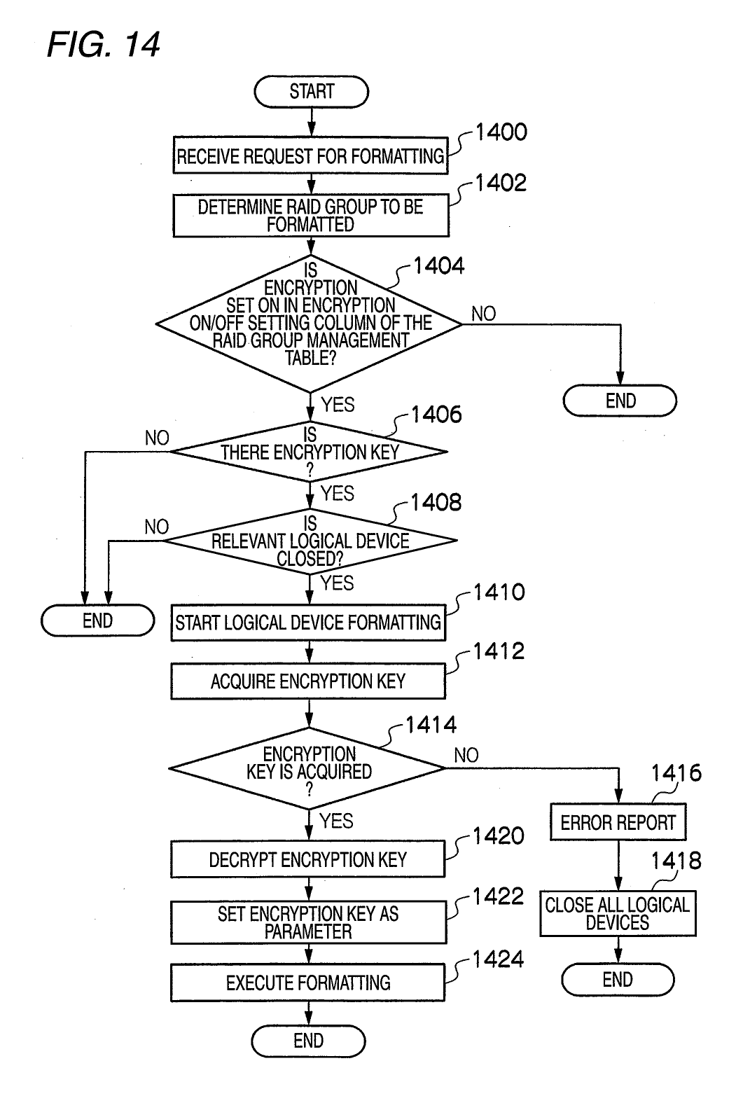

FIG. 14 is a flow chart for explaining the formatting for encryption. First, when the SVP 32 receives a request for formatting from the management client (step 1400), the SVP refers to the RAID group management table (FIG. 6) to present a list of RAID groups to the management client.

The SVP determines an RAID group to be formatted based on an input from the management client (step 1402).

Next, the management program of the SVP refers to the management table to check the encryption on/off setting column of the RAID group to be formatted (step 1404). When encryption is set off, the program determines that the RAID group cannot be formatted for encryption and terminates the process.

When the SVP determines that encryption is set on, it continues the process for encryption formatting. Even if encryption is set off, when the SVP finds that “Enable” is set in the management table in FIG. 5 for all disk adaptors forming the RAID group, the SVP may continue the process instead of terminating the same because formatting for encryption can be substantially performed for the RAID group.

Next, the SVP 32 refers to the shared memory 22 to check whether there is an encryption key or not (step 1406). When there is no encryption key, the process is terminated because formatting for encryption cannot be carried out. Alternatively, the encryption formatting process may be attempted again after generating an encryption key.

Next, the SVP refers to the logical device management table shown in FIG. 8 to check the status of the logical devices to which data is to be transferred belonging to the RAID group that is the destination of migration (step 1408). When the logical devices are not in the closed state, the SVP terminates the process.

When the logical devices are closed, the SVP instructs the microprocessor of each of the plurality of disk adaptors forming the RAID group that is the destination of migration to execute a logical device formatting process.

The microprocessor of each disk adaptor activates a logical device formatting program in the local memory 42 (step 1410) to acquire an encrypted encryption key from the shared memory (step 1412). When at least one of the microprocessors fails to acquire an encryption key (step 1414), the microprocessor advices the SVP 32 or the SVP and the host computer 12 that formatting for encryption has failed (step 1416).

The SVP determines that an encryption key cannot be acquired although it exists in the shared memory 22, and the SVP identifies all logical devices belonging to the RAID group that is the destination of migration by referring to the management table shown in FIG. 8 and closes them (step 1418).

When all microprocessors successfully acquire an encryption key, each microprocessor decrypts the code set in the encryption key (step 1420) and sets parameters including information on the encryption key in the local memory 42 (step 1422). Each microprocessor refers to a logical address/physical address conversion table in the shared memory 22 and stores a physical address associated with the logical device that is a destination of migration in the local memory 42.

The FCA internal controllers of the relevant disk adaptors forming the RAID group to which logical devices at the destination of migration belongs cause the encryption/decryption circuits to acquire the encryption key by referring to the local memories. Zero data encrypted by the acquired encryption key is written in the memory areas of the HDD identified by the physical addresses to complete the encryption formatting process (step 1424).

High speed formatting carried out at the HDDs cannot involve encryption. Therefore, even when the management client selects high speed formatting, encryption formatting is forcibly switched to standard formatting that is formatting of the HDDs by the disk adaptors in the course of the encryption formatting process.

The decryption of the encryption key may be carried out by one of the relevant disk adaptors, and the decrypted encryption key mat be transferred to the rest of the relevant disk adaptors through the connection unit.

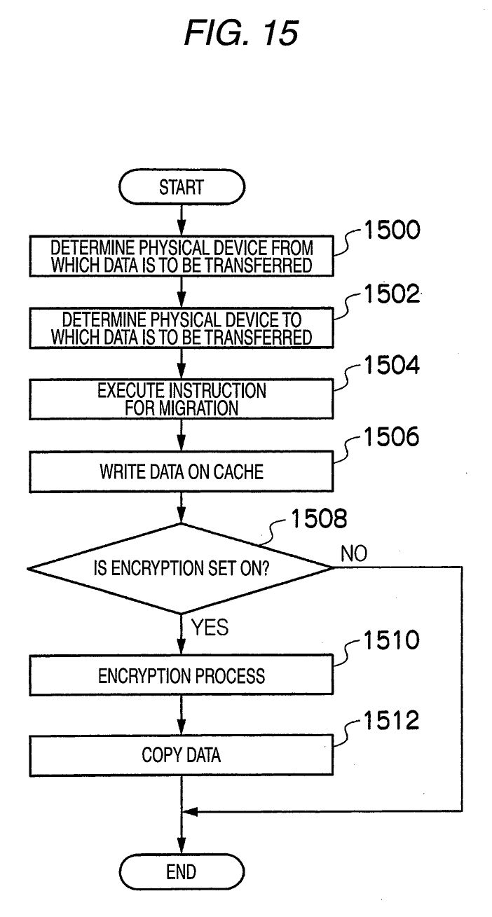

A description will now be made on migration processes performed after the formatting for encryption is completed with reference to the flow chart shown in FIG. 15.

When the SVP 32 recognizes a migration request from the management client along with a request for setting logical devices from and to which data is to migrate, the SVP identifies the RAID group including the logical devices from which data is to migrate by referring to the logical device management table shown in FIG. 8.

The SVP determines the HDDs (physical devices) forming the RAID group by referring to the HDD management table shown in FIG. 9 (step 1500). The SVP similarly determines the HDDs to which data is to migrate (step 1502).

When the SVP receives an instruction for the execution of migration (step S1504), the microprocessor of each of the plurality of disk adaptors connected to the HDDs at which migration starts reads data of interest from physical addresses in the plurality of HDDs associated with the logical devices and stages the data onto the cache memory 26 (step 1506).

Each of the plurality of disk adaptors connected to the HDDs at the designation of migration refers to the RAID group management table and the logical device management table to determine whether encryption is set on for the RAID group to which the logical devices at the destination of migration belongs (step 1508).

When it is determined that encryption is set on, the disk adaptors perform an encryption process by sequentially reading items of data of interest from the cache memory (step 1510) and sequentially copies the encrypted data into the plurality of HDDs associated with the logical devices at the destination of transfer (step 1512).

When encryption is set off for the RAID group, the disk adaptor transmits a notice to the management client through the SVP, the notice indicating that a process of converting a plain text into an encrypted text utilizing migration cannot be carried out. Upon receipt of the notice, the SVP inquires of the management client whether to continue the migration process or not.

When the management client chooses to continue migration, the disk adaptors receive the decision and sequentially copy the data read from the cache memory into the HDDs without encrypting the data.

When the management client chooses to stop migration, the SVP terminates migration.

Write commands dispatched from the host computer to the transferring logical devices which do not encrypt data since the beginning of migration are dispatched to the logical devices of the transfer destination during or after the migration, and write data is encrypted and stored in the logical device of the transfer destination.

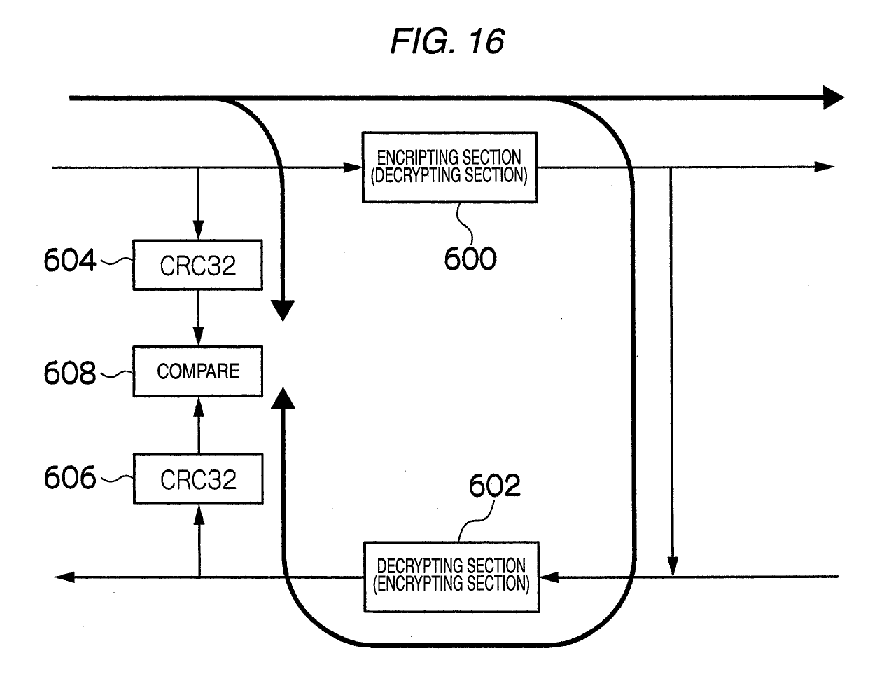

For example, the encryption/decryption circuit 60 has a configuration as shown in FIG. 16, and the circuit performs encryption and decryption in association with each other to provide security of data. Referring to FIG. 16, the encryption/decryption circuit includes an encrypting section 600 encrypting data, a decrypting section 602 decrypting encrypted data, a first CRC32 generator 604 generating a CRC32 checksum (security code) from unencrypted plain test data, a second CRC generator 606 generating a CRC checksum from decrypted plain text data, and a comparison circuit 608 comparing the CRC32 generated by the first generator and the CRC32 checksum generated by the second generator.

When data is encrypted, the encryption/decryption circuit 60 supplies a plain text to the first generator 604 to generate a CRC32 checksum while encrypting the data at the encrypting section 600.

The encryption/decryption circuit decrypts the data encrypted by the encrypting section at the decrypting section 602 and supplies the resultant plain text data to the second generator 606. The comparison circuit 608 acquires redundancy data from each of the first generator 604 and the second generator 606 and compares the data. When the comparison reveals that there is no match between the data, the internal controller 54 is notifies of such a result.

Upon receipt of the notice, the internal controller reports the comparison result to the managing device through the microprocessor 44. The managing device notifies the user of the comparison result.

Decryption of data is the reverse of data encryption. The encrypting section 600 serves as a decrypting section, and the decrypting section 602 serves as an encrypting section.

The encryption/decryption circuit decrypts an encrypted text while generating a CRC32 checksum from the encrypted data before the data is decrypted. The circuit encrypts the decrypted data and generates a CRC32 checksum from the encrypted data. Then, the two CRC32 checksums are compared with each other.

The encryption/decryption apparatus shown in FIG. 16 is characterized as follows. The apparatus includes an encrypting section encrypting data, a decrypting section decrypting encrypted data, a first security code generating section generating a first security code, a second security code generating section generating a second security code, and a comparison section comparing the first security code and the second security code. When data is encrypted, the first security code generating section generates the first security code from unencrypted data. After the data is encrypted by the encrypting section, the encrypted data is decrypted by the decrypting section. Then, the second security code generating section generates the second security code from the decrypted data, and the comparison section compares the first security code and the second security code. When data is decrypted, the first security code generating section generates the first security code from undecrypted data. After the data is decrypted by the decrypting section, the decrypted data is encrypted by the encrypting section. Then, the second security code generating section generates the second security code from the encrypted data, and the comparison section compares the first security code and the second security code.

Therefore, in the data encrypting/decrypting apparatus shown in FIG. 16, consistency between unencrypted data and encrypted data can be guaranteed while data is encrypted. Consistency between undecrypted data and decrypted data can be guaranteed while decrypting encrypted data.

According to the above description of the embodiment, an encryption key is generated by the SVP. Alternatively, a disk adaptor enabled for encryption may generate an encryption key and may store the key in the local memory. Where there is a plurality of disk adaptors enabled for encryption, a representative disk adaptor may generate an encryption key and may transfer the encryption key to the other disk adaptors.

What is claimed is:

1. A storage apparatus controlling transmission of information between a host computer and a memory device, the apparatus comprising:
a first adaptor controlling transmission of data to and from the host computer;
a plurality of second adaptors controlling transmission of the data to and from the memory device;
a connection circuit connecting the first adaptor and the second adaptors; and
a controller controlling transmission of the data between the first adaptor and the second adaptors, wherein
at least one of the plurality of second adaptors is an encryption-enabled adaptor having an encryption module for encrypting the data, and the encryption-enabled adaptor stores encrypted data in the memory devices.

2. A storage apparatus according to claim 1, wherein at least one of the plurality of second adaptors is an encryption-disabled adaptor in which the encryption module is not provided or in which the encrypting function is set off although the encryption module is provided, the encryption-disabled adaptor storing the data in the memory device without encrypting the same.

3. A storage apparatus according to claim 2, where in the controller transfers data requiring encryption to the encryption-enabled adaptor and transfers data requiring no encryption to the encryption-disabled adaptor.

4. A storage apparatus according to claim 1, wherein the encryption-enabled adaptor is an adaptor in which the encrypting function of the encryption module is set on.

5. A storage apparatus according to claim 1, comprising:
a plurality of the memory devices; and
a managing device, wherein
the managing device manages a memory area formed by the plurality of memory devices by dividing the area into parts.
whether encryption of the data is required or not can be set for each division of the memory area.

6. A storage apparatus according to claim 5, wherein:
the managing device manages a plurality of RAID groups formed by dividing the plurality of memory devices; and
whether encryption of the data is required or not can be determined for each of the RAID groups.

7. A storage apparatus according to claim 6, wherein the managing device determines that encryption is required for the an RAID group when it is determined that all of the plurality of second adaptors connected respectively to the plurality of memory devices belonging to the RAID group are encryption-enabled adaptors.

8. A storage apparatus according to claim 2, wherein data provided in a memory device associated with the encryption-disabled adaptor is encrypted by the encryption-enabled adaptor when the encryption-disabled adaptor causes the data to migrate to the encryption-enabled adaptor.

9. A storage apparatus according to claim 2, wherein a memory device connected to the encryption-enabled adaptor is formatted by the encryption-enabled adaptor using encrypted format data.

10. A data processing method executed by a storage apparatus controlling transmission of information between a host computer and a memory device, comprising the steps of:
determining whether encryption is required or not for data transmitted from the host computer;
transmitting the data to a first interface control section controlling interface to the memory device and having an encrypting function when it is determined that encryption is required for the data; and
transmitting the data to a second interface control section controlling interface to the memory device and having no encrypting function when it is determined that encryption is not required for the data.
